(19) United States
(12) Patent Application Publication
(10) Pub. No.: US 2014/0007961 A1
(43) Pub. Date: Jan. 9, 2014

(54) APPARATUS FOR MAINTAINING A HARVESTED ORGAN VIABLE AND TRANSPORTABLE

(71) Applicants: Stig Steen, Lund (SE); Audrius Paskevicius, Lund (SE); Benjamin King, Takaka (NZ)

(72) Inventors: Stig Steen, Lund (SE); Audrius Paskevicius, Lund (SE); Benjamin King, Takaka (NZ)

(73) Assignee: VIVOLINE MEDICAL AB, Lund (SE)

(21) Appl. No.: 14/006,324

(22) PCT Filed: Mar. 23, 2012
(86) PCT No.: PCT/SE12/00045

§ 371 Date: Sep. 23, 2013

(30) Foreign Application Priority Data
Mar. 23, 2011 (SE) 1100213-6

(51) Int. Cl. A01N 1/02

(52) U.S. Cl. CPC A01N 1/0289
USPC 137/565.17

(57) ABSTRACT

An apparatus for enclosing an organ after harvesting and before implantation, having; a vessel enclosing a fluid, a connection tube for connecting a circulation hose to the organ for passing a fluid to the organ by a pump, and a degassing hose extending from the connection tube to the vessel. A pinch valve is arranged in the degassing hose. During a degassing phase, the pinch valve is opened to allow fluid flow from the pump, via the circulation hose to the connection tube and via the degassing hose to the vessel for expelling air entrapped in the fluid flow system. A balloon is arranged to prevent fluid flow via the connection tube to the organ during the degassing phase. A sterility arrangement closes the vessel at the top and may be replaced by further sterility arrangements without compromising the sterility.

### FIELD OF INVENTION

The present invention relates to an apparatus for maintaining an organ, such as a heart, viable and transportable for a long time, such as up to and exceeding 24 hours.

### BACKGROUND OF THE INVENTION

U.S. Pat. No. 7,176,015 discloses a transportable organ preservation system for maintaining an organ viable for successful implantation into a human recipient. The system comprises a cylinder that contains 255 litre of oxygen sufficient for up to 34 hours of perfusion time. The organ is immersed in a perfusion fluid, which is oxygenated and pumped through the heart via the aorta of the heart. The system containing the heart, the oxygen cylinder, the pump assembly and hoses are all arranged in a tray, which is inserted in a commercial cooler device having cooling blocks and an insulation for maintaining the cylinder and the heart at a temperature of about 4° C. The sterility is maintained by a lid, which closes the cylinder.

The above described system may comprise components which are required for a transportable preservation system for harvested organs. However, the disclosed system lacks monitoring devices that may indicate any condition that may jeopardize the organ.

Another drawback with this system is the fact that the hoses in the fluid circulation system are connected after harvesting the organ, which takes time from the total time that the organ can be maintained in a viable state.

A further drawback with this system is that the sterility may be jeopardized during certain conditions, and there is a need for an improved sterility system.

Another drawback with this system is that heart cannot be arranged in different positions in dependence of the size and condition of the heart or organ.

The patent publication WO 2011/037511 A1 discloses a method and a device for treatment of a heart after harvesting and before transplantation, in which a perfusion fluid is circulated through the coronary blood vessels of the heart. The perfusion fluid is cardioplegic and comprises an oncotic agent exerting an oncotic pressure larger than about 30 mmHg and the perfusion is performed at a pressure which is at least 15 mmHg and at least 15 mmHg lower than said oncotic pressure. The perfusion may be intermittent. WO 2011/037511 A1 is assigned to the assignee of the present application and its technical contents is included in the present application by reference.

Thus, there is a need in the art for an organ preservation system that is more integrated in the entire procedure involved in an organ transplantation.

More specifically, there is a need for a system that guaranties sterility in most situations.

Moreover, there is a need in the art for a heart preservation system that is optimized for intermittent perfusion of the heart between harvesting and implantation and during the implantation procedure.

### SUMMARY OF THE INVENTION

Accordingly, an object of the present invention is to mitigate, alleviate or eliminate one or more of the above-identified deficiencies and disadvantages singly or in any combination.

A further object of the invention is to provide an apparatus, which is adapted to perform the method disclosed in the mentioned patent publication WO 2011/037511 A1.

According to a first aspect, there is provided an apparatus for enclosing an organ after harvesting and before implantation, comprising: a vessel enclosing a fluid; a connection tube for connecting a circulation hose to the organ for passing a fluid to the organ by means of a pump; a degassing hose extending from the connection tube from a position adjacent the connection of the tube with an inlet part of the organ and to said vessel; and a valve member, for example a pinch valve, arranged in said degassing hose for preventing fluid flow therein; whereby during a degassing phase, the valve member is opened to allow fluid flow from the pump, via said fluid flow hose to said connection tube and via said degassing hose to said vessel for expelling air entrapped in said fluid flow system.

In an embodiment, the connection tube may comprise an occlusion member arranged to prevent fluid flow via said connection tube to said organ during said degassing phase. The occlusion member may be a balloon member which is connected to a pump via a balloon hose for expansion of the balloon member by means of said pump in order to obstruct fluid flow via the connection tube to said organ during said degassing phase, and for flattening said balloon member after said degassing phase for permitting fluid flow via said connection tube to said organ. The apparatus may comprise a pressure monitor for monitoring the pressure in said balloon member for determining the state of expansion of said balloon member. The balloon hose may extend from said balloon to said pump and further to a source of fluid, for example a bag of saline solution or the fluid in said vessel.

In a further embodiment, the apparatus may comprise a space arranged to receive said circulation hose and said degassing hose in a rolled arrangement, whereby said fluid flow hose and said degassing hose has a predetermined length which is adapted so that said connection tube may be moved to an organ being harvested from a donor and said connection tube being connected to the organ before moving the organ out of the donor body and to said vessel, and so that the organ during the implant procedure may be moved from the vessel to the body of the recipient and implanted in the recipient while still connected to said connection tube. There may further be arranged recesses adjacent said space for enclosing said fluid flow hose and said degassing hose in a friction grip.

In another embodiment, the apparatus may further comprise a sterility arrangement which closes the vessel at the top thereof, and which may be replaced by a second, third etc sterility arrangement without compromising the sterility.

### BRIEF DESCRIPTION OF THE DRAWINGS

Further objects, features and advantages of the invention will become apparent from the following detailed description of embodiments of the invention with reference to the drawings, in which:

FIG. 1 is a schematic view of an embodiment of an apparatus for enclosing a heart between harvesting and implantation.

FIG. 2 is a schematic view of another embodiment of the apparatus.

FIG. 3 is a schematic view of a portion of the embodiment of FIG. 2.

FIG. 4 is a perspective view of a cooling device for enclosing the apparatus according to the above embodiments.

FIG. 5 is a view from above of the apparatus to be enclosed in the cooling device of FIG. 4.

FIG. 6 is a perspective view of the insert to be inserted in the cooling device according to FIG. 4.

FIG. 7 is a view from above of the insert according to FIG. 6.

FIG. 8 is a schematic view of an embodiment of the invention.

### DETAILED DESCRIPTION OF EMBODIMENTS

Below, several embodiments of the invention will be described. These embodiments are described in illustrating purpose in order to enable a skilled person to carry out the invention and to disclose the best mode. However, such embodiments do not limit the scope of the invention. Moreover, other combinations of the different features are possible within the scope of the invention.

The below embodiments disclose apparatuses and methods for handling an organ between harvesting the organ in a donor and up to implant of the organ in a recipient.

Most organs cannot withstand a long ischemic time, i.e. a condition without supply of nutrients and oxygen, which are normally supplied via the blood. For example, a heart cannot withstand more than about 20 minutes, while other organs, such as the lungs can withstand up to 40 minutes or more.

The outcome of an organ transplantation is for example dependent on the condition of the organ before harvesting. All efforts should be undertaken to maintain the donor and its organs in as good a condition as possible before harvesting. Such efforts may for example include the method steps and processes disclosed in the patent publication WO 2010/077200 A1, the contents of which are included in its entirety in the present specification by reference. Generally, the methods of this publication involves that the potential donor is treated as vigorously as possible before death, and that circulation and ventilation is maintained after the time the potential donor is declared brain dead, in order to avoid ischemic conditions. After obtaining consent from the potential donor in advance and/or his/her next of kin, the potential donor is treated according to a strategy that maintains the organs in a viable condition, after brain death is declared.

Next, the organs are harvested, in Sweden normally within 24 hours after declaration of brain death.

The organs are examined for viability and stored, normally under hypothermic conditions until transplantation.

Finally, the organs are implanted in the recipient.

All steps are important for the final result of the organ transplantation.

The present embodiments generally deal with the procedure between harvesting and implantation of an organ, especially of a heart.

In a presently used procedure, the harvesting starts with exposing the heart to a cardioplegic and cold saline fluid, which is infused in the heart. The heart stops beating and the circulation stops. The heart may now be in the risk for an ischemic condition, since no blood flow is present. However, the infused fluid may provide sufficient oxygen and nutrients for avoiding ischemic conditions. The heart is made free from the donor and the aorta is cut and maintained as long as possible.

The heart is examined for viability, involving, for example, checking for aortic valve insufficiency and other examinations. Aortic valve insufficiency may be examined by adding a fluid to the aorta and examine whether the fluid level decreases. Since the fluid has no other escape way except via the aortic valve, this is a good test of the patency of the aortic valves. It is mentioned that the fluid may escape via the coronary vessels. However, the pressure for passing through the coronary vessels is normally higher than a few centimeter of water pillar, which means that no flow will pass through the coronary vessels during such an aorta valve test. The heart may also be examined by angiographic methods in order to detect defects in the coronary vessels.

A connector tube is attached to the aorta and the heart is moved to a preservation apparatus and connected in a preservation circuit, for example as described in the above-mentioned U.S. Pat. No. 7,176,015 or the patent publication WO 2010/077200 A1. Cold preservation solution is circulated through the coronary vessels via the aorta. Other strategies may as well be used.

In the construction of an apparatus for maintaining an organ between harvesting and implantation, a number of considerations may be taken into account, a few of which are mentioned below:

1) The apparatus is intended to be transported from the donor site to the recipient site when comprising the organ. Thus, the apparatus may have a size and weight which enables a single person to carry the apparatus during loading and unloading from a transport facility, such as an airplane, a car, an ambulance etc. or be built in such a way that this type of transport is possible, for example being provided with wheels.

2) The apparatus may be required to maintain function without access to external supply of electricity during portion of the time between harvesting and implantation. The time between harvesting and implantation may be, for example, 24 hours, and at least a few hours may be without access to electric power. Thus, the apparatus should be constructed for maintaining its operation during at least 2 hours, 3 hours, 4 hours, 5 hours or 6 hours, without access to external electric power, i.e. driven on battery power.

3) The apparatus may be constructed for connection to a supply of gas for oxygenation of the perfusion fluid. The apparatus may be provided with internal gas supply for at least a portion of the time between harvesting and implantation.

4) The apparatus may provide a sterile environment for the organ, during harvesting and placement of the organ in the apparatus, during preservation and evaluation of the organ in the apparatus, and during the implantation procedure. This means that the vessel comprising the organ may need to be opened and closed several times and the sterility should be maintained during such procedures.

5) The apparatus should be constructed to fit into the current procedure for harvesting in an operation theatre as well as the procedure during implantation.

6) The system should be constructed to be cost effective without jeopardizing safety.

The below described embodiments consider at least some of the above mentioned constraints as well as other that will be elucidated during the detailed description of the embodiments.

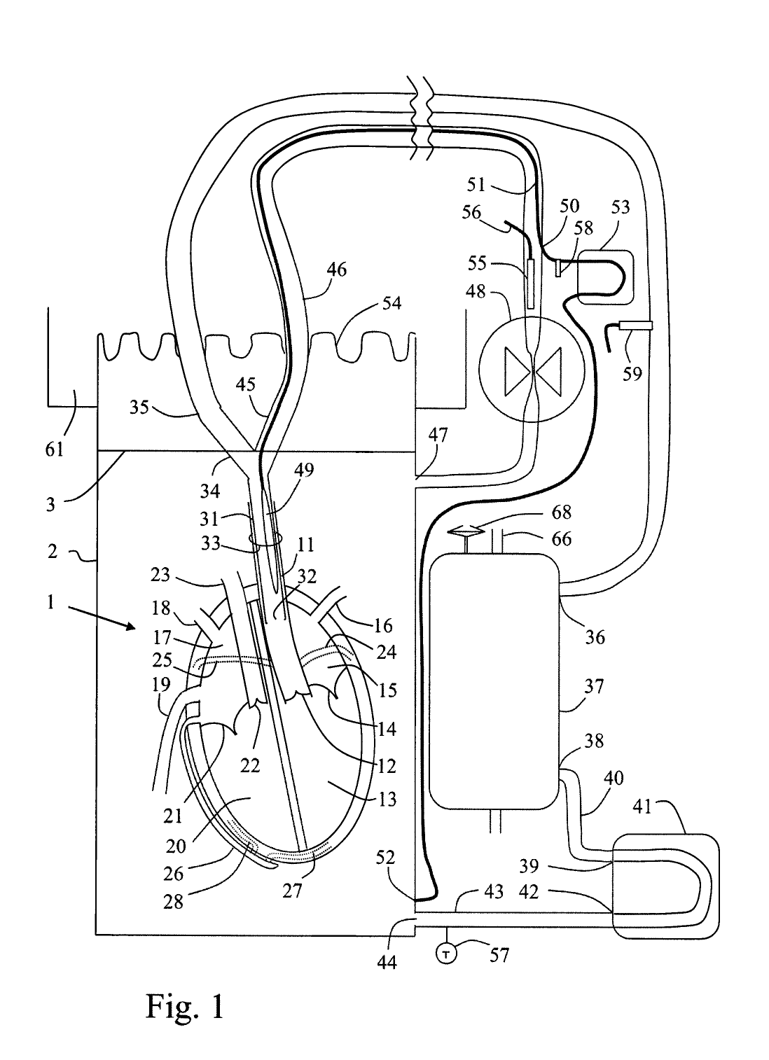

A first embodiment will be described with reference to FIG. 1, which discloses a schematic diagram of an apparatus for maintaining an organ during preservation. The organ described below is a heart, but other organs may be used.

A heart 1 is shown arranged in a vessel 2, the heart being immersed in a preservation solution, the upper surface of which is indicated by reference numeral 3.

The heart is shown schematically from the front and includes an aorta 11, ending in an aortic valve 12, which opens into a left ventricle 13 of the heart. A mitral valve 14 connects the ventricle 13 with a left atrium 15. During normal operation, blood enters the left portion of the heart via four pulmonary veins 16, one of which is shown in FIG. 1. The blood fills the left atrium 15 and the left ventricle 13 during diastole, while the mitral valve 14 is open and the aortic valve 12 is closed. During contraction, the left atrium 15 is first contracted forcing further blood into the left ventricle 13. Then, the left ventricle 13 is contracted, whereupon the mitral valve 14 is closed and the aortic valve 12 is opened and the blood is forced out into the body via the aorta 11.

The right portion of the heart operates in a similar way, while blood enters the right atrium 17 via two veins, superior vena cava 18 and inferior vena cava 19. During diastole, blood fills the right atrium 17 and right ventricle 20 via tricuspid valve 21. During contraction of the heart, the blood in the right ventricle 20 is forced to the lungs via pulmonary valve 22 and pulmonary artery 23.

The heart muscle is provided with blood supply via a left coronary artery 24 and a right coronary artery 25, each dividing into capillaries. The coronary blood is returned to the right atrium 17 via coronary sinus 26, which collects blood from several coronary veins, such as middle cardiac vein 27 and great cardiac vein 28. The coronary sinus 26 opens into the right atrium 17 via Thebesian valve (not shown), which prevents backflow into the coronary sinus.

During harvesting of the heart, the heart is paralyzed via infusion of a cardioplegic fluid into the coronary circulation of the heart. The cardioplegic fluid is normally cold to induce a hypothermic condition in the heart. The aorta is cut in a position to keep it as long as possible so that a tube may be attached to the aorta for antegrade supply of coronary fluid flow.

In FIG. 1, the heart 1 is shown removed from the donor and with a connection member such as a connection tube 31 arranged in the aorta 11. The heart 1 is immersed in the vessel 2 so that the entire aorta 11 is immersed below the fluid surface 3, in order to keep the aorta moist. There is only one connection required during the harvesting of the organ, namely between the tube 31 and the aorta, which connection can be made relatively fast.

The connection tube 31 is inserted in the aorta so that the end 32 of the tube is well above the aortic valve 12 and the openings of the coronary arteries 24 and 25. The coronary arteries open normally between 5 and 10 mm above the aortic valve 12. The tube 31 may be provided with several shoulders and one or several outer sutures 33, so that no fluid flow may leak out and pass outside the tube 31 between the outer surface of the tube and the aorta. Since the aortic valve 12 is closed, all fluid passing through the tube 31 flows through the coronary arteries.

In the embodiment of FIG. 1, the connection tube 31 is divided in a first branch 34, which is connected to a flexible circulation hose 35. The other end of the circulation hose 35 is connected to the fluid outlet 36 of an oxygenator 37. An inlet 38 of the oxygenator is connected to the outlet 39 of a pump 41 via a flexible hose 40. An inlet 42 of the pump 41 is connected to an outlet 44 of the vessel 2 via a flexible hose 43. The oxygenator may be provided with a ventilation arrangement 68 at a top position of the oxygenator for ventilating any entrapped air to the surrounding atmosphere for example via a hydrophobic membrane, for example during the priming of the circulation system.

A circulation circuit is formed from the outlet 44 of the vessel 2, via pump 41 and oxygenator 37 and circulation hose 35 to the aortic root. Since the aortic valve is closed, the fluid passes into the coronary arteries 24, 25 and via the coronary sinus 26 to the right atrium 17 and further out to the surrounding vessel.

The fluid circulation is controlled by the pump 41. The pump may be operated and controlled in several different modes of operation as will be explained below.

During the connection of the heart to said circulation circuit, parts of the heart and the system may comprise enclosed gas, normally air. Such gas should be prevented from entering the coronary arteries, since the gas may be detrimental for the circulation of the fluid in the coronary vessels and may block capillaries.

Thus, there is provided a degassing system. The connection tube 31 is divided into a second branch 45, which is connected to a flexible degassing hose 46 ending at an inlet 47 in the upper part of vessel 2. The degassing hose 46 is normally closed by a valve member, such as a pinch valve 48, as shown in FIG. 1.

An occlusion member, such as a balloon 49, is arranged in the tube 31. The balloon 49 may be inflated via a narrow balloon hose 51 arranged inside the degassing hose 46 and passed through the wall of the degassing hose at 50 before the pinch valve 48. The balloon hose 51 ends in a second outlet 52 of the vessel 2. A pump 53 may pump fluid from the outlet 52 and via hose 51 into balloon 49 in order to inflate the balloon 49. Alternatively, the fluid may be taken from a bag comprising saline fluid.

A pressure sensor 58 is arranged to measure the pressure inside the balloon 49 in order to determine proper operation of the balloon circuit. The pressure sensor may be arranged at any position between the balloon and the pump 53, for example as shown in FIG. 1.

A degassing cycle may be as follows. First, the circulation pump 41 is operated at a slow speed in order to pass preservation fluid into the circulation hose 35 and the first branch 34 and into the connection tube 31 and further into the aorta 11. The pinch valve 48 is open. Substantially no pressure is exerted in the aorta. Consequently, no fluid will enter the coronary vessels, but any gas or air enclosed in the aorta or the tube 31 will ascend to a level above the balloon 49. When the space below the balloon is filled with fluid, the balloon pump 53 is activated in order to expand the balloon 49 so that the connection tube 31 is sealed off. Now, the perfusion fluid passes from the circulation pump 41, via the circulation hose 35 and via the degassing hose 46 to the inlet 47 and to vessel 2. During this flow, all gas or air entrained in the circulation hose 35 and the degassing hose 46 is displaced out of the system and into vessel 2, wherein it rises up to the surface 3. When the degassing is completed, the circulation pump 41 is stopped, the pinch valve 48 is closed and the balloon pump 53 is reversed to empty the balloon 49 from fluid, which is pumped back into the outlet 52. The operation is monitored by the pressure sensor 58. Now, the system is prepared for circulation.

To ensure proper removal of gas, the system may begin perfusion with the pinch valve 48 partially open to allow a small flow to pass through the hose 46 which will allow any remaining gas to rise but will also allow the perfusion pressure to be reached as is set by the user.

After degassing, the circulation phase may start. The circulation may be intermittent, so that a circulation period of 15 minutes may be followed by a rest period of 60 minutes. The perfusion fluid may be cardioplegic so that the heart is in diastole without any activity, and in a hypothermic condition, such as below 10° C., see further below.

After the rest period, a mixing, oxygenation and degassing phase may be performed. During this phase, the balloon 49 is maintained in the inflated state, the pinch valve 48 is opened and the fluid is circulated through the circuit but not the heart in order to mix the solution, stabilize the temperature in the hoses and system and oxygenate the fluid before perfusion. During this phase, any sedimentation of for example erythrocytes is counteracted. Thus, it is prevented that an accumulation or too high concentration of erythrocytes, cells or other particles may enter the coronary vessels. In addition, the perfusion fluid to be entered in the coronary vessel is fresh fluid taken from the bottom of the vessel 2 and agitated for some time. Consequently, the fresh fluid is well mixed, oxygenated and has the desired temperature, which may be monitored by a temperature sensor 57.

A pressure sensor 55 may be arranged in the degassing hose 46 or the second branch 45, for example close to the pinch valve 48. Electric wires 56 for the pressure sensor 55 may pass out through the wall of the degassing hose 46. The pressure sensor may be arranged at any position along the degassing hose 46, since the pressure during perfusion operation is constant along the hose 46 (except for hydrostatic pressure differences, which can be mathematically compensated), since the pinch valve 48 is closed and there is no fluid flow in the degassing hose 46. Thus, a pressure is monitored which is independent of the flow rate of the circulation fluid in the circulation hose 35.

The pressure sensors 55 and 58 should be calibrated or zeroed when the heart and the circulation system have been arranged in proper position and has been deaired or degassed. The calibration is performed when the circulation pump 41 is stopped and the pinch valve 48 is closed.

During circulation, the pump 41 is operated so that a pressure is exerted on the aortic root, which is within specified limits. At the same time, the flow rate is monitored so that it does not exceed a specified limit. For example, the aortic root pressure is adjusted to 25 mmHg and the flow rate is monitored not to exceed 100 ml/min. When the aortic root pressure is about 25 mmHg, this may result in a flow of for example 50 ml/min. The exact flow rates and pressures are determined by the operator in dependence of the organ to be perfused.

The system may be operated with a substantially constant pressure or with a substantially constant flow rate or any combination thereof.

Normally, the pressure in the aortic root needs to be above a threshold limit in order to pass fluid through all of the coronary vessels. Such a threshold pressure may be about 10 mmHg, and is dependent on the particular organ to be perfused. A small perfusion will occur at a low pressure. However, in the present embodiments all of the coronary vessels should be perfused. Such total perfusion is believed to be present when the pressure is above said threshold limit. The threshold limit is dependent on the temperature of the perfused organ.

Gas or air may be entrapped in different portions of the heart. Since normally no circulation is present in the atriums and ventricles, any entrapped air may remain stationary and is not harmful. However, if any gas should enter above the aortic valve into the aorta, such gas will be removed at the periodic degassing procedure, prior to every perfusion cycle.

A further pressure sensor 59 may be arranged at the circulation hose 36, which may be used for detection of possible air locks. The pressure sensor 55 in the degassing hose 46 and the pressure sensor 59 in the circulation hose 36 are arranged at a fixed relative height position. Thus, these two pressure sensors 55 and 59 should have the same pressure reading (they are zeroed at the same time). However, if an air bubble is left anywhere in the degassing hose 46, the pressure sensor 55 would measure a pressure which is different from the pressure sensor 59 in the circulation loop, whereby measures may be undertaken to remove such air.

One or several temperature sensors may be arranged in the system, such as temperature sensor 57 arranged at the outlet 44 of the vessel 2. Another temperature sensor may be arranged adjacent the connection tube 31 in order to measure the temperature of the fluid being introduced into the coronary vessels of the heart. A further temperature sensor may be arranged in a cooling system, described below.

As shown in FIG. 1, the upper rim of the vessel 2 is provided with undulations 54. The undulations are sized so as to enclose and retain, for example by friction, the hoses 35 and 46, so that the heart may be arranged in any desired height position and be retained in the adjusted position.

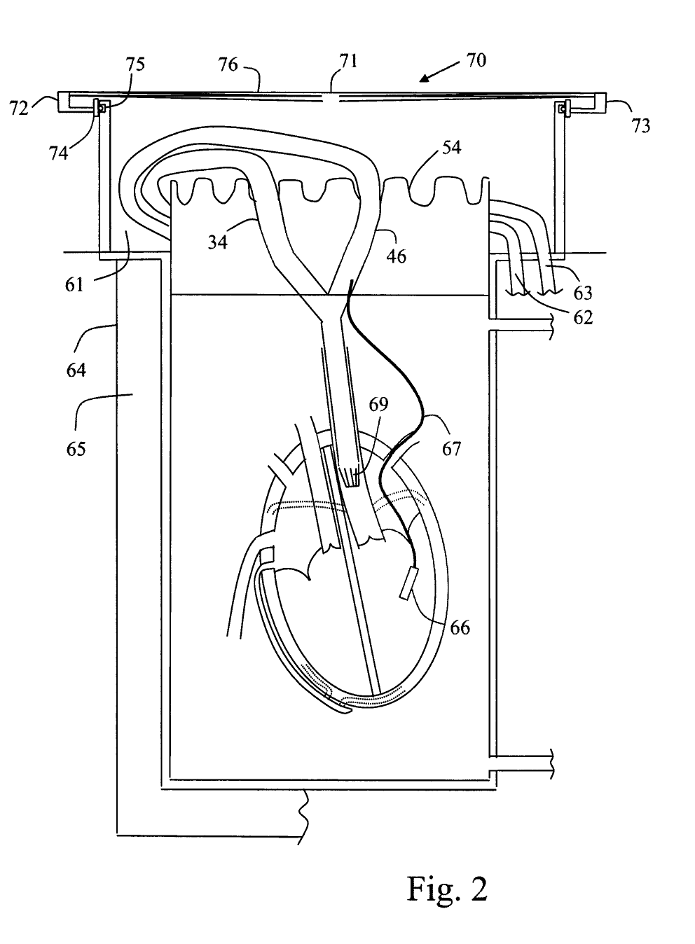

As shown in FIG. 2, the hoses 34 and 46, after being attached to the undulations, may be arranged in a space or recess 61 arranged outside the undulations 54. After having passed one or several revolutions in the recess 61, the hoses 34 and 46 pass out from the recess 61 via two holes 62 and 63, as shown in FIG. 2. These holes are sealed.

In order to keep sterility, the recess may be sealed towards the top via a sterility arrangement 70. The sterility arrangement comprises a top web 71 extending between a left rim 72 and a right rim 73. There are also a front rim and a back rim, not shown in FIG. 2, which together form a rectangular area. The top web 71 covers the entire rectangular area. The rims 72 and 73 are attached to a ring portion 74, which encircles the recess 61. The ring portion 74 is sealed towards the recess 61 via an O-ring sealing 75 or other suitable method. Inside the rectangular area, a sterile operation cloth 76 is arranged in a folded condition. The entire system is sterilized with the sterility arrangement in place.

When the heart should be arranged into the vessel, the top web 71 is torn or peeled away and removed. The sterility cloth 76 is folded out for covering the area around the recess 61, thereby forming a sterile area, while the circular area encircled by the recess 61 is left free. The heart may now be arranged in the vessel 2.

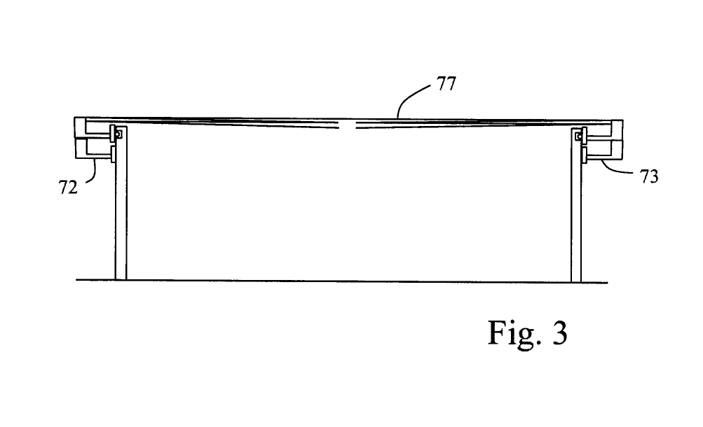

When the heart is in place and all the initial procedures are performed, the vessel 2 should be closed again in a sterile manner. Now, a second sterility arrangement 77 is added above the first sterility arrangement 70 while the first sterility arrangement is pushed down the outer surface of the recess 61 or stacked on top of the previous arrangement. The old sterile cloth 76 may now be removed if desired or pushed down outside the vessel 2. The arrangement of the new sterility arrangement 77 is shown in FIG. 3.

Since the entire area has been kept sterile all the time, the second sterility arrangement forms a closure of the vessel 2. Now, the vessel may be transported to the recipient. Sterility has been maintained all the time.

If it is required to examine the organ, the same procedure may be performed several times. The vessel and the recess 61 may be constructed for encompassing up to four sterility arrangements, or any number of sterility arrangements desired.

By sterility is meant the type of sterility maintained in an operation theatre. Thus, the air in the operation theatre is filtered by sterile filters before entering the operation theatre area. The body of the donator or recipient is covered by sterile cloths and all normal actions for maintaining sterility is performed. The same type of sterility is intended in the present embodiment.

When the heart is to be implanted in a recipient, the vessel 2 is opened as described above. After preparation of the operation theatre in a conventional manner, the heart can be taken up from the vessel 2, without detaching the heart from the tube 31 and the hoses 35 and 46. A sufficient length of hoses 35 and 46 is arranged in the recess 61 so that the heart can be moved to the implant location. Consequently, each of the hoses may have a length of about 2 meters. Any suitable length can be used.

Because the heart is attached to the connection tube 31, it can easily be manipulated and arranged in the implant site. In addition, the heart can be perfused as long as possible until the moment of disconnection at the implant site. During the implant procedure, which may take some 60 minutes or longer, it is normally desired to add cardioplegic fluid to the heart. Such cardioplegic fluid may be delivered each 20 minutes of implant time. Since the heart is still attached to the circulation circuit, the pump 41 can be used for the supply of cardioplegic solution, for example according to the following procedure:

After 20 minutes, the implant procedure is halted. First, the pressure sensor is zeroed, so that it measures a correct pressure. Then, the circulation pump 41 is started with a slow speed to fill the aorta and the tube 31 with fluid. The pinch valve 48 is open. Any air in the aorta and the tube 31 will ascend above the level of the balloon 49. Now, the balloon pump 53 expands the balloon 49 in order to occlude the connection tube. The circulation pump 41 will now pump fluid via the circulation hose 35 and the degassing hose 46 in order to remove all gas in the system to the vessel. When the gas has been removed, the balloon pump 53 is reversed and the balloon 49 is collapsed or deflated. Then, the pinch valve 48 is closed. The circulation pump 41 is operated to increase the pressure in the tube 31 to a desired pressure value. Alternatively, the pump 41 is operated at a desired flow rate. Cold cardioplegic fluid is provided to the coronary vessels of the heart. The fluid will pass out from the right atrium of the heart, but is easily removed from the implant site. The advantage of this procedure is that it is assured that no gas enters the coronary vessels, thereby ensuring that the entire heart is kept paralyzed and perfused with oxygenated fluid. The entire procedure may take one or a few minutes.

Next time the cardioplegic fluid should be supplied to the heart under implantation, the pressure sensor need not be zeroed once again, which means that time may be saved.

As shown in FIG. 2, a further pressure sensor 66 may be arranged in the left ventricle and the pressure sensor 66 may be connected to the system operation device via a wire 67, which may be passed out via the degassing line 46. The pressure sensor 66 may be used for observing a possible leak by the mitral valve 12. If there is a leak, the pressure inside the left ventricle 13 will increase. Since the heart is cardioplegic, such an increase may result in that the walls of the heart become unduly tensioned. Such a tension may also prevent the coronary vessels from being perfused, at least those vessels passing close to the wall of the heart. The pressure sensor 66 is calibrated at the same time as the system pressure sensor 55. If the pressure inside the left ventricle increases above a predetermined threshold, this is an indication that the mitral valve is not sufficiently closed and any counteraction may be performed. Such a pressure threshold may be an increase of 10 mmHg.

One counteraction may be to introduce a hose, which relieves the pressure inside the left ventricle. Another counteractions may be to arrange a small suture through the tips of the mitral vanes, thereby maintaining the mitral vanes in a proper position. Further counteractions may be used.

In order to protect the mitral valves, the end of the tube 31 may be provided with a redirection arrangement, which redirects the fluid flow in a radial direction. Such a direction arrangement may be arranged as several slits 69 in the peripheral wall of the end portion of the tube. The fluid flow is redirected from a longitudinal flow along the direction of the tube 31 and out through the slits perpendicular to the longitudinal flow in a radial direction. Thus, the mitral valve will be saved.

Another measure for saving the mitral valves may be to arrange the tube 31 and the first branch 34 so that the circulation fluid in the tube 31 forms a vortex when passing down towards the aortic valve 12. Thus, the circulation fluid will tend to move close to the walls of the aorta and enter the coronary vessels 24, 25 more easily, while saving the aortic valve 12. In addition, any air will easily pass upwards in the center of the vortex for removal via degassing hose 46.

As further shown in FIG. 2, the entire vessel 2 may be surrounded by an insulation space 64, so that the temperature may be kept low. The insulation space may in addition comprise a phase change material 65 having a low temperature, such as 4° C., and keeping the entire vessel 2 at a desired temperature. The phase change material may be ice or a wax or any other known material.

The heart should be stored at a low temperature, for example in the order of 4° C. to 10° C. Thus, the entire vessel 2 is arranged in a cooling device having an insulated enclosure and a device for developing and maintaining a low temperature.

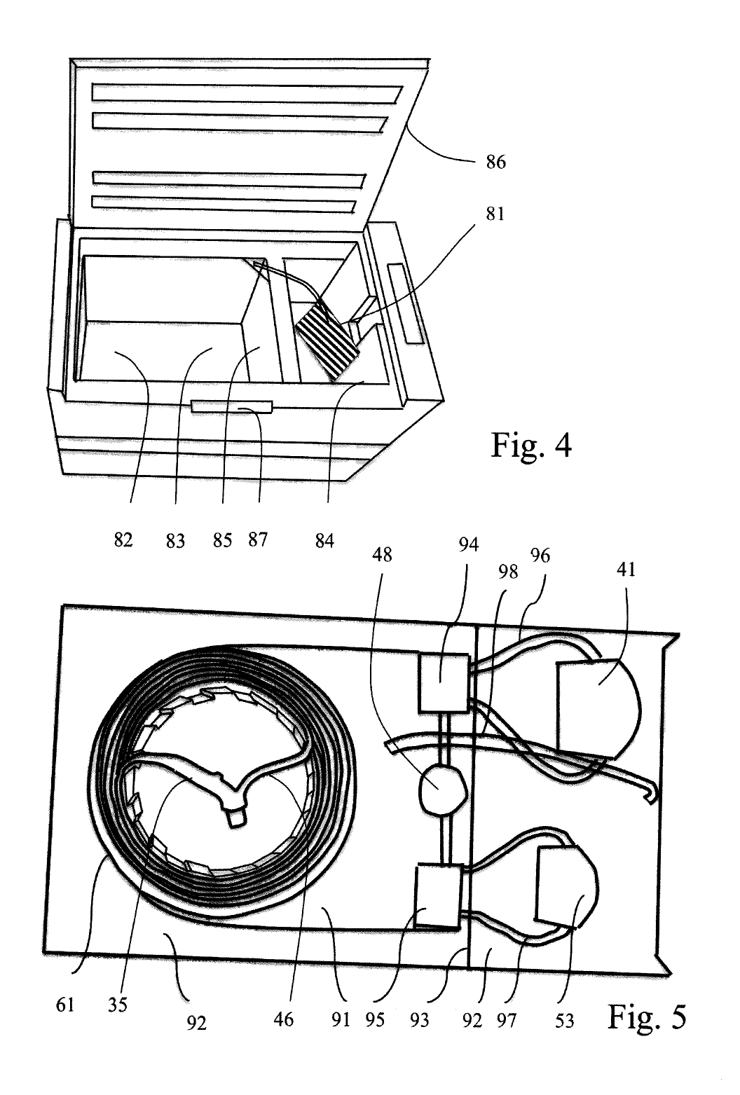

Such a cooling device may be a conventional refrigerator having a compressor, condenser and an evaporator as shown in FIG. 4, such as a Waeco CoolFreeze portable refrigerator. The cooling system thereof comprises a Danfoss BD 35 compressor 81 that is connected to a plate evaporator 82 arranged in the sidewalls of a cooling compartment 83 in the portable refrigerator. The compressor and the condenser are arranged in a ventilated and warm compartment 84 of the portable refrigerator. The warm compartment 84 is separated from the cold compartment 83 by an insulated wall 85. The cold compartment 83 is surrounded by insulation at all sides. A lid 86 may close the two compartments and be locked by a locking arrangement 87. The lid 86 or housing may be provided with a handle so that the entire portable refrigerator can be carried.

The evaporator becomes cold when the compressor is operated. The evaporator may be arranged in the phase change material to keep it cold and to store energy in it, or rather remove energy there from, for maintaining a low temperature when electricity is not accessible.

The electronics handling the system may be arranged in the warm compartment 84, while the vessel 2 and the phase change material and insulation may be arranged in the cold compartment 83 of the portable refrigerator.

FIG. 5 is a perspective view from above showing the vessel 2 with the hoses 35 and 46 arranged in a ring arrangement inside the recess 61. FIG. 5 shows a single use component 91 and a reusable component 92.

The reusable component 92 comprises the two pumps 41 and 53 as well as a number of connectors for the pressure sensors and the temperature sensors. These components are arranged in the warm compartment 83. The partition wall 85 is arranged below the line 93. Thus, the pinch valve 48 is arranged in the cold compartment 84, however well insulated. Below the pumps 41 and 53, the electronics are arranged, including a control processor, chargeable batteries and a power controller. Another portion of the reusable component 92 is arranged in the cold compartment 83 and forms a seat for the single use component 91.

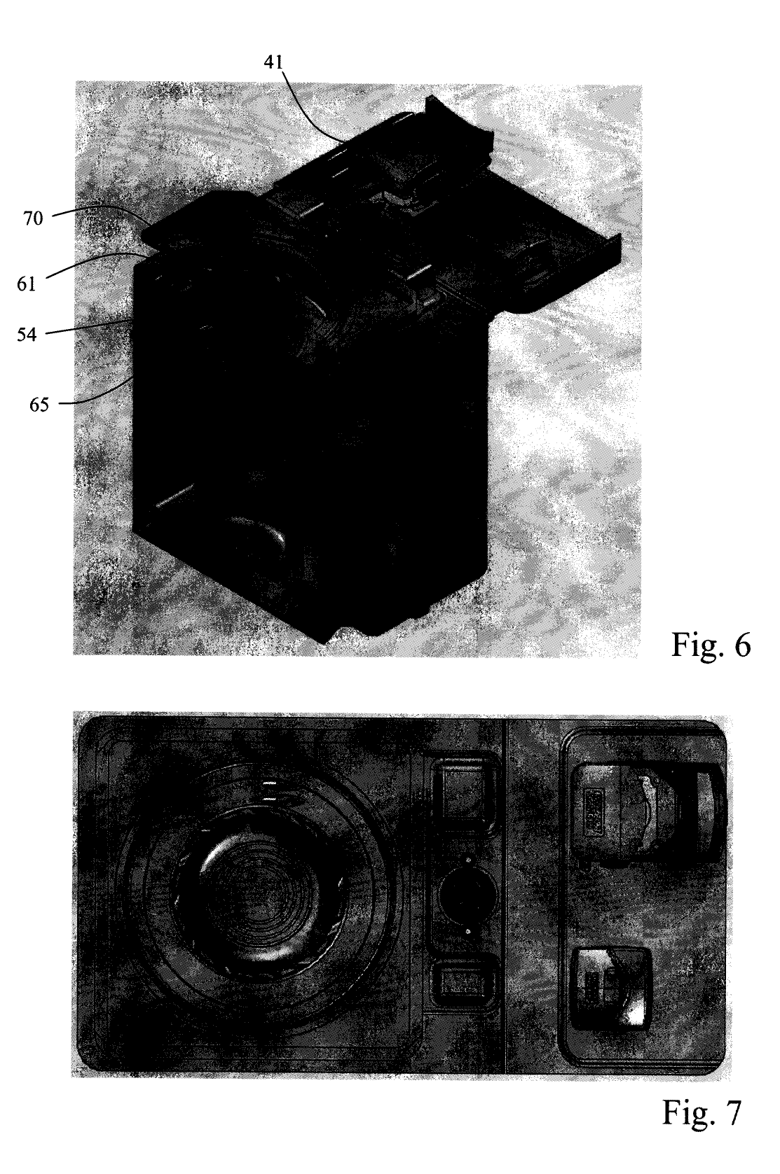

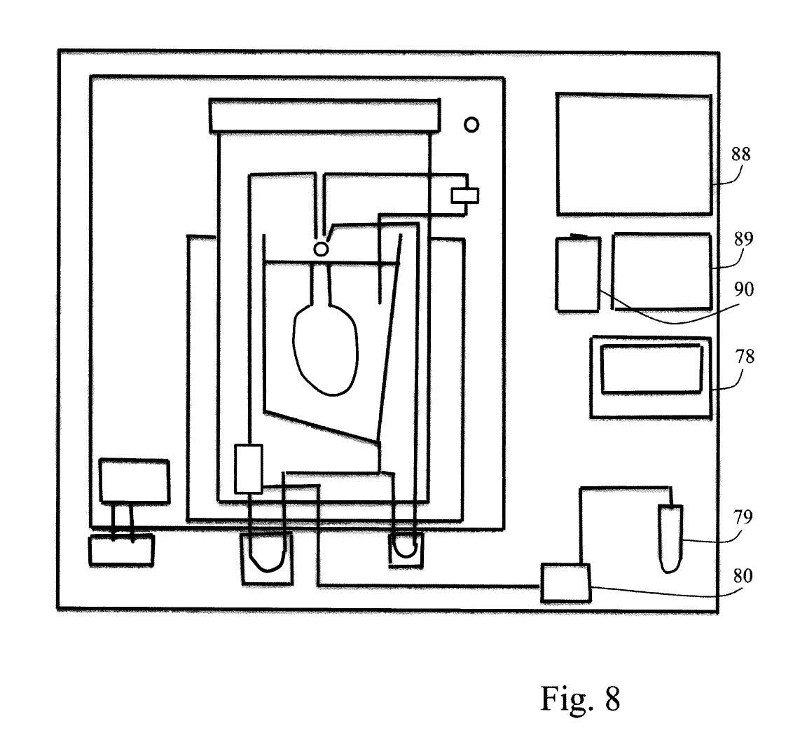

FIG. 6 is a partially broken perspective view of the reusable component 92 and parts of the single use component 91, comprising the vessel 2, having the undulating portion 54 and the recess 61 visible. The sterile arrangement 70 is arranged at the upper portion of the recess 61.

As appears from FIG. 5, the single use component 91 comprises two holders 94 and 95 for holding the pump segment portions 96 and 97 for the circulation pump 41 and the balloon pump 53, respectively. The holders 94 and 95 also hold a portion of the degassing hose 46 for passage through the pinch valve 48. In this manner, the single use component can be easily inserted in place in the reusable portion with the hoses in the right position for the two pumps and the pinch valve. The setup will be fast.

A gas supply hose 98 is also shown in FIG. 5. The gas supply hose 98 is attached to the gas inlet 66 of the oxygenator, shown in FIG. 1. The oxygenator also comprises a gas outlet 67, which may be open to the atmosphere. The gas supply hose 98 may be attached to a ventilation connector providing carbogen gas to the oxygenator. The gas may comprise 95% oxygen and 5% carbon dioxide. A valve may be included which administers gas only when there is fluid flow through the oxygenator.

The oxygenator may be a standard oxygenator such as a Terumo FX05 oxygenator, which is a fiber oxygenator having several hundred thin filaments of a gas permeable and liquid impermeable material. The filaments are arranged side by side inside a cylinder and potted in an elastomeric material at each end, thereby forming a closed space outside the filaments and inside the cylinder. The inside of each filament is available from outside the potting material. Gas is transported inside the filaments and the liquid to be oxygenated is transported outside the filaments. Because of the small diameter of the filaments, the contact surface between the gas inside the filaments and the liquid outside the filaments will be large, for example about 1 square meter. In this manner, the oxygenator may operate similar to the lungs.

The oxygenator may also comprise a heat exchanger so that the liquid in the oxygenator may be cooled or heated by circulation of a fluid.

As mentioned above, the evaporator of the cooling system is arranged close to the sidewalls of the vessel 2 and cools the vessel 2 and the fluid in the vessel. In addition, the entire cold compartment will keep the vessel 2 and the fluid therein cold and at a temperature desired, such as about 4° C.

The fluid intended to be used in the apparatus described above for preservation of a heart may be the fluid defined in the above-mentioned patent publication WO 2011/037511 A1.

One example is a fluid comprising: 60 g/L of Dextran 40; 7.0 g/L of NaCl; 1.71 g/L of KCl; 0.22 g/L of CaCl₂*2H₂O; 0.17 g/L of NaH₂PO₄*H₂O; 1.26 g/L of NaHCO₃; 0.24 g/L of MgCl₂*6H₂O; 1.98 g/L of D(+) glucose, erythrocytes at a hematocrit of at least 5% and optionally 50 ml of albumin (5%). Because the fluid comprises erythrocytes, it may transport oxygen to the heart. The glucose is nutrition. The Dextran and the albumin form an oncotic pressure, which is sufficient to counterbalance the hydrostatic pressure.

The fluid may be present in a volume of about 2 liters. If the flow rate through the coronary vessel is about 30 ml/min during a perfusion period of 15 minutes, the volume passing the heart is about 450 ml, i.e. about 25% of the volume of fluid in the vessel 2. Thus, if the entire fluid in the vessel is oxygenated, the oxygen may be sufficient for four consecutive perfusion periods, without further supply of oxygen. The heart is in a hypothermic condition, in which the oxygen demand and the nutritional demand is reduced.

If the supply of oxygen or carbogen gas is interrupted, the oxygenator may be provided with normal air, which comprises about 20% oxygen. This will be sufficient in most situations at least during a short time.

The batteries are dimensioned for operating the circulation for at least 4 hours, without recharging. The phase change material is able to maintain the entire vessel 2 and the fluid therein at a temperature of below about 10° C. for at least 4 hours. If there is no external electric power supply, the compressor may be shut down.

Thus, the apparatus may operate on batteries only during at least 4 hours without jeopardizing the heart to be preserved. This is sufficient for most transports by airplane to any desired recipient site within Europe. The battery capacity may be dimensioned for any operation time desired, such as 6 hours, 8 hours or more.

FIG. 8 is a schematics diagram of the apparatus according to the embodiment of FIG. 1. As is shown in FIG. 8, the pressure sensors and the temperature sensors are connected to a computer 88, which may be arranged external of the apparatus, or inside the warm compartment 84. The computer is powered by a power supply 89 and chargeable batteries 90 are arranged to provide power when external power is not available. The computer operates the pumps and the compressor.

In addition, a gas bottle 79 may be arranged external of the apparatus, or inside the warm compartment 84. A valve 80 controls the flow of gas to the oxygenator. The valve is controlled by the computer 88.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims or embodiments, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Although the present invention has been described above with reference to specific embodiment and experiments, it is not intended to be limited to the specific form set forth herein. Rather, the invention is limited only by the accompanying claims and, other embodiments than those specified above are equally possible within the scope of these appended claims.

1. An apparatus for enclosing an organ after harvesting and before implantation, comprising:
a vessel enclosing a fluid;
a connection tube for connecting a circulation hose to the organ for passing a fluid to the organ by means of a pump;
a degassing hose extending from the connection tube from a position adjacent the connection of the connection tube with an inlet part of the organ and to said vessel; and
a valve member arranged in said degassing hose for preventing fluid flow therein;
whereby during a degassing phase, the valve member is opened to allow fluid flow from the pump, via said circulation hose to said connection tube and via said degassing hose to said vessel for expelling air entrapped in said fluid flow system.

2. The apparatus according to claim 1, wherein said connection tube comprises an occlusion member arranged to prevent fluid flow via said connection tube to said organ during said degassing phase.

3. The apparatus according to claim 2, wherein said occlusion member is a balloon member which is connected to a pump via a balloon hose for expansion of the balloon member by means of said pump in order to obstruct fluid flow via the connection tube to said organ during said degassing phase, and for flattening said balloon member after said degassing phase for permitting fluid flow via said connection tube to said organ.

4. The apparatus according to claim 3, further comprising a pressure monitor for monitoring the pressure in said balloon member for determining the state of expansion of said balloon member.

5. The apparatus according to claim 3, wherein said balloon hose extends from said balloon to said pump and further to a source of fluid, for example a bag of saline solution or the fluid in said vessel.

6. The apparatus according to claim 1, further comprising a space arranged to receive said circulation hose and said degassing hose in a rolled arrangement, whereby said circulation hose and said degassing hose has a predetermined length which is adapted so that said connection tube may be moved to an organ being harvested from a donor and said connection tube being connected to the organ before moving the organ out of the donor body and to said vessel, and so that the organ during the implant procedure may be moved from the vessel to the body of the recipient and implanted in the recipient while still connected to said connection tube.

7. The apparatus according to claim 6, further comprising recesses arranged adjacent said space for enclosing said circulation hose and said degassing hose in a friction grip.

8. The apparatus according to claim 1, further comprising a sterility arrangement which closes the vessel at the top thereof, and which may be replaced by further sterility arrangements without compromising the sterility.
